(19) United States
(12) Patent Application Publication
(10) Pub. No.: US 2017/0236612 A1
(43) Pub. Date: Aug. 17, 2017

(54) Method Of Enhancing Surface Electrical Conductivity Of Conductive Plastics And Conductive Plastic Films Produced Thereby

(71) Applicant: Delphi Technologies, Inc., Troy, MI (US)

(72) Inventor: Evangelia Rubino, Warren, OH (US)

(21) Appl. No.: 15/042,188

(22) Filed: Feb. 12, 2016

(51) Int. Cl. H01B 1/24; H01B 1/22; H01B 3/30; H01B 3/00

(52) U.S. Cl. CPC H01B 1/24; H01B 3/004; H01B 1/22; H01B 3/305

(57) ABSTRACT

A method of enhancing surface electrical conductivity of an article formed of a conductive polymer material, such as a conductive polymer film, includes the step of providing an article formed of a conductive polymer. The conductive polymer is made up of a dielectric polymeric material and conductive fibers. A desired pressure is applied to at least a portion of the article while simultaneously heating at least a portion of the article to a desired temperature. The desired pressure and the desired temperature are maintained on at least a portion of the article for a desired time period. This method reduces a polymer-rich skin layer on the surface of the conductive polymer material and helps to randomize the orientation of the conductive fibers on the surface.

### TECHNICAL FIELD OF THE INVENTION

The invention relates to a method of enhancing surface electrical connectivity in conductive plastics, in particular to enhancing surface electrical connectivity by applying heat and pressure to a conductive plastics surface.

### BACKGROUND OF THE INVENTION

Conductive composite materials, such as polymeric materials filled with electroconductive fillers or fibers, produces a polymer-rich skin layer on the surface when molded or extruded. This polymer-rich skin layer reduces electrical conductivity of the outer surface, providing a less than optimal electrical contact surface. Current methods of removing the polymer-rich skin layer to enhance surface conductivity of the formed product include mechanical surface treatments, e.g. grinding or polishing, electrical surface treatments, e.g. plasma etching, chemical surface treatments, e.g. acid etching. Other methods that have been used to improve surface conductivity include incorporation of water soluble resins and inherently conductive polymers into the composite matrix or adding additional conductive layers to the surface, e.g. metal films or conductive paints. Material processing parameters have also been varied to enhance surface conductivity, but with only limited success. Therefore, a simpler method of enhancing surface conductivity of conductive polymeric materials remains desired.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

### BRIEF SUMMARY OF THE INVENTION

In accordance with an embodiment of the invention, a method forming a conductive polymer film having enhanced surface electrical conductivity is provided. The method includes the steps of providing an article formed of a conductive polymer comprising a dielectric polymeric material and conductive fibers, applying a desired pressure to at least a portion of the article while simultaneously heating the portion of the article to a desired temperature, and maintaining the desired pressure and the desired temperature on the portion of the article for a desired time period. The desired pressure may be about 27,580 kilopascals while the desired temperature may be in a range from about 163° C. to about 190° C. and the desired time period is about 10 minutes. The dielectric polymeric material may be a polyamide and the conductive fibers may be nickel plated carbon fibers.

In accordance with another embodiment of the invention, a method forming a conductive polymer film having enhanced surface electrical conductivity is provided. The method includes the steps of providing an extruded conductive polymer tape comprising a dielectric polymeric material and conductive fibers, applying a desired pressure to the extruded conductive polymer tape while simultaneously heating the extruded conductive polymer tape to a desired temperature and maintaining the desired pressure and the desired temperature for a desired time period. The method may further include the steps of providing extruded conductive polymer tape in the form of a plurality of conductive polymer tapes comprising a dielectric polymeric material and conductive fibers and arranging the plurality of conductive polymer tapes in a desired orientation. The desired orientation of the plurality of conductive polymer tapes may include arranged in an adjacent parallel fashion, arranged in an overlapping perpendicular fashion, or arranged in an interwoven fashion.

In accordance with yet another embodiment of the invention, a conductive polymer film having enhanced surface electrical conductivity is provided. The conductive polymer film is formed by the method described above.

### BRIEF DESCRIPTION OF THE SEVERAL VIEWS OF THE DRAWING

The present invention will now be described, by way of example with reference to the accompanying drawings, in which:

FIG. 1 is a flowchart of a method of enhancing surface electrical conductivity of an article formed of a conductive polymer material according to several embodiments;

FIG. 2 is a side cross section view of an article formed of a conductive polymer between the platens of a heated press according to several embodiments;

FIG. 3 is a photograph of an extruded length of conductive polymer tape prior to being processed according to the method of FIG. 1;

FIG. 4 is a photograph of a plurality of conductive polymer tapes arranged in an adjacent parallel fashion prior to being processed according to the method of FIG. 1;

FIG. 5 is a photograph of a plurality of conductive polymer tapes arranged in an overlapping perpendicular fashion prior to being processed according to the method of FIG. 1;

FIG. 6 is a photograph of a plurality of conductive polymer tapes arranged in an interwoven fashion prior to being processed according to the method of FIG. 1;

FIG. 7 is a photomicrograph of a surface of a conductive polymer film prior to being processed according to the method of FIG. 1;

FIG. 8 is a photomicrograph of a surface of a conductive polymer film after being processed according to the method of FIG. 1 according to one embodiment; and

FIG. 9 is a photograph of a conductive polymer film formed of a plurality of conductive polymer tapes after being processed according to the method of FIG. 1 according to another embodiment.

### DETAILED DESCRIPTION OF THE INVENTION

Presented herein is a method of enhancing the surface electrical conductivity of an article formed of an extruded conductive polymer material containing a polymer material and conductive fibers, e.g. an extruded tape, an extruded cable, or a conductive plastic film. The method involves the application of heat and pressure to at least a portion of the article for a predetermined time period. These conductive plastic articles may be used to provide shielding for electromagnetic compliance (EMC) and/or electromagnetic interference (EMI). Without subscribing to any particular theory of operation, the electrical conductivity of the surface of the conductive polymer material is enhanced or improved by diminishing the polymer-rich skin layer on the surface described in the BACKGROUND OF THE INVENTION by redistributing the polymer material and reorienting the conductive fibers.

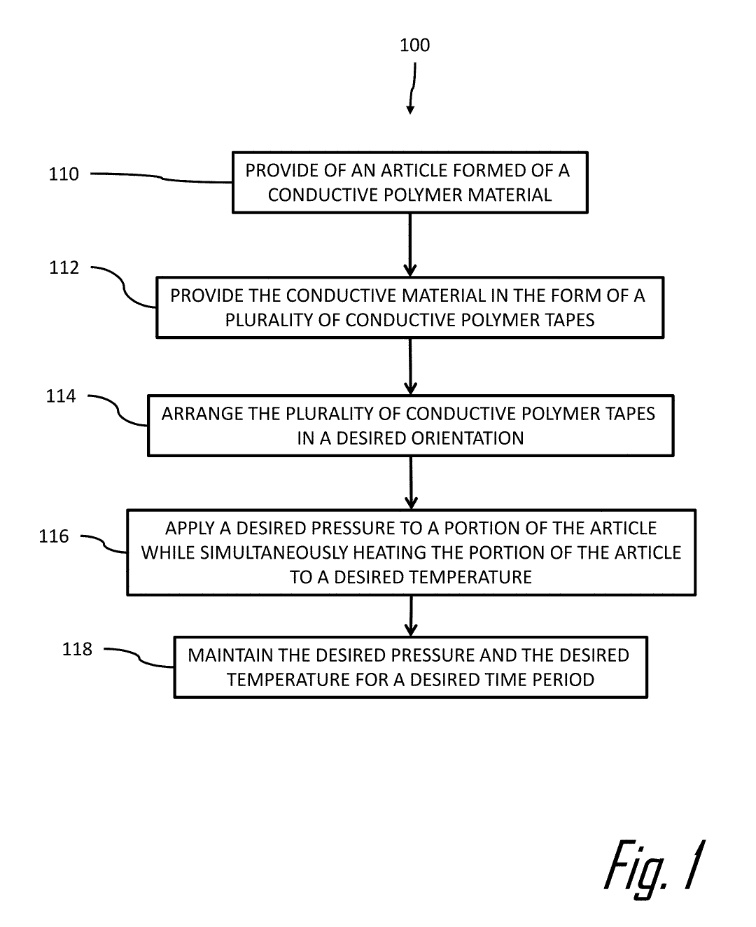

FIG. 1 shows a flow chart of a method 100 for enhancing the surface electrical conductivity of an article 10 formed of a conductive polymer material 12.

STEP 110, PROVIDE AN EXTRUDED ARTICLE FORMED OF A CONDUCTIVE POLYMER MATERIAL, includes providing the extruded article 10 formed of the conductive polymer material 12 comprising a dielectric polymeric material 14 and conductive fibers 16, such as the extruded tape formed of a conductive polymer material 12 describe above.

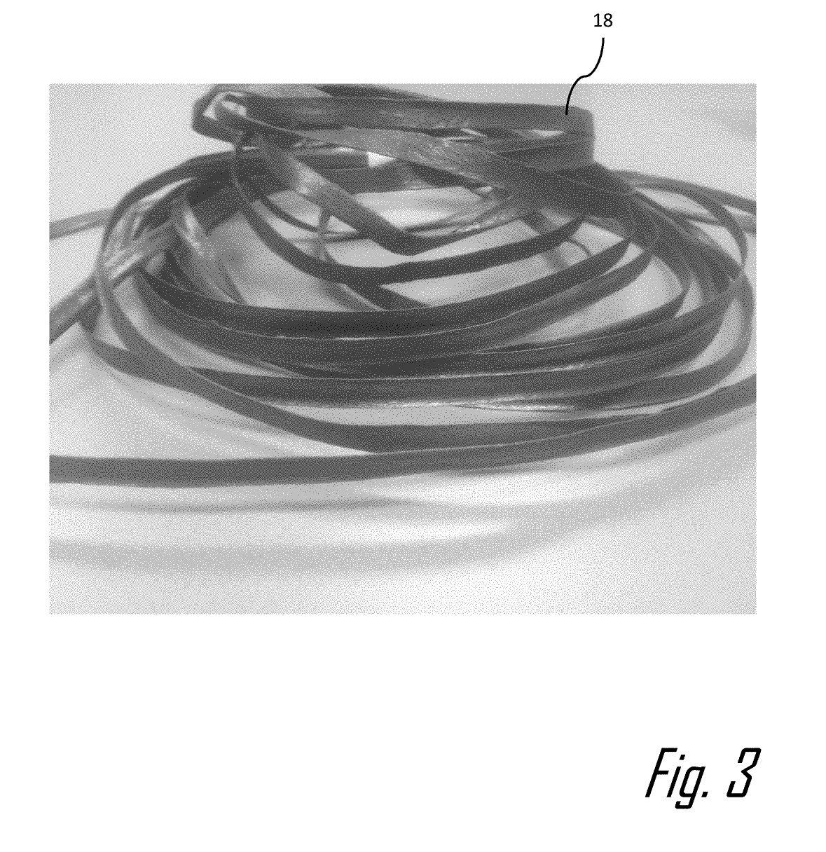

STEP 112, PROVIDE THE CONDUCTIVE POLYMER ARTICLE IN THE FORM OF A PLURALITY OF CONDUCTIVE POLYMER TAPES, is an optional step that includes providing the conductive polymer article 10 in the form of a plurality of conductive polymer tapes 18, as shown in FIG. 3.

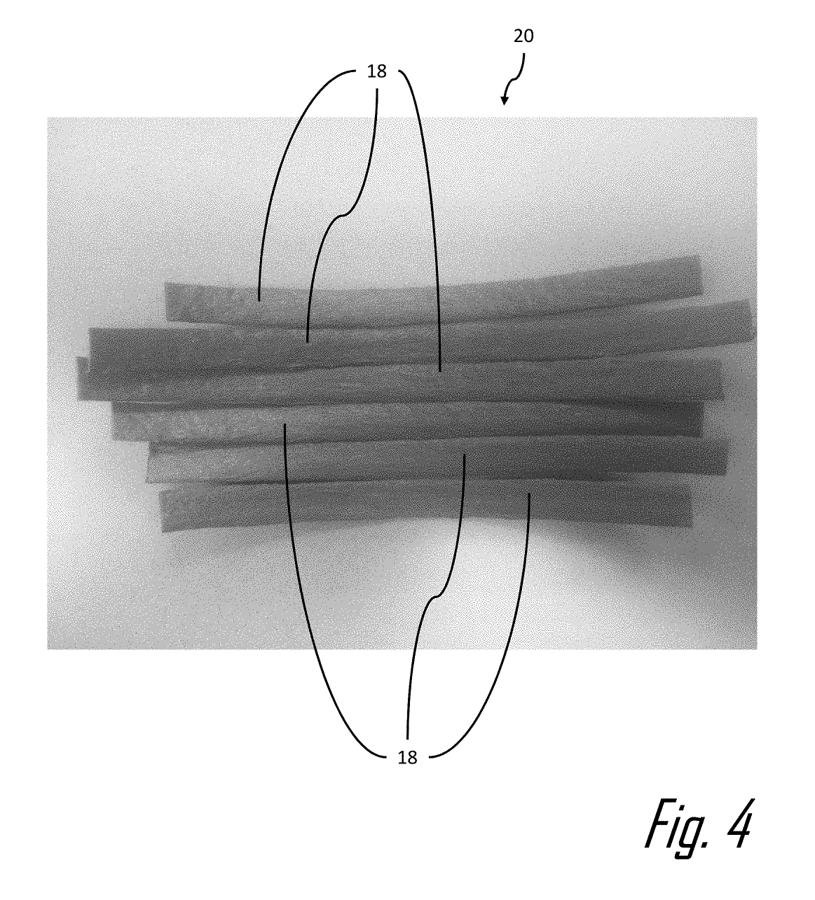

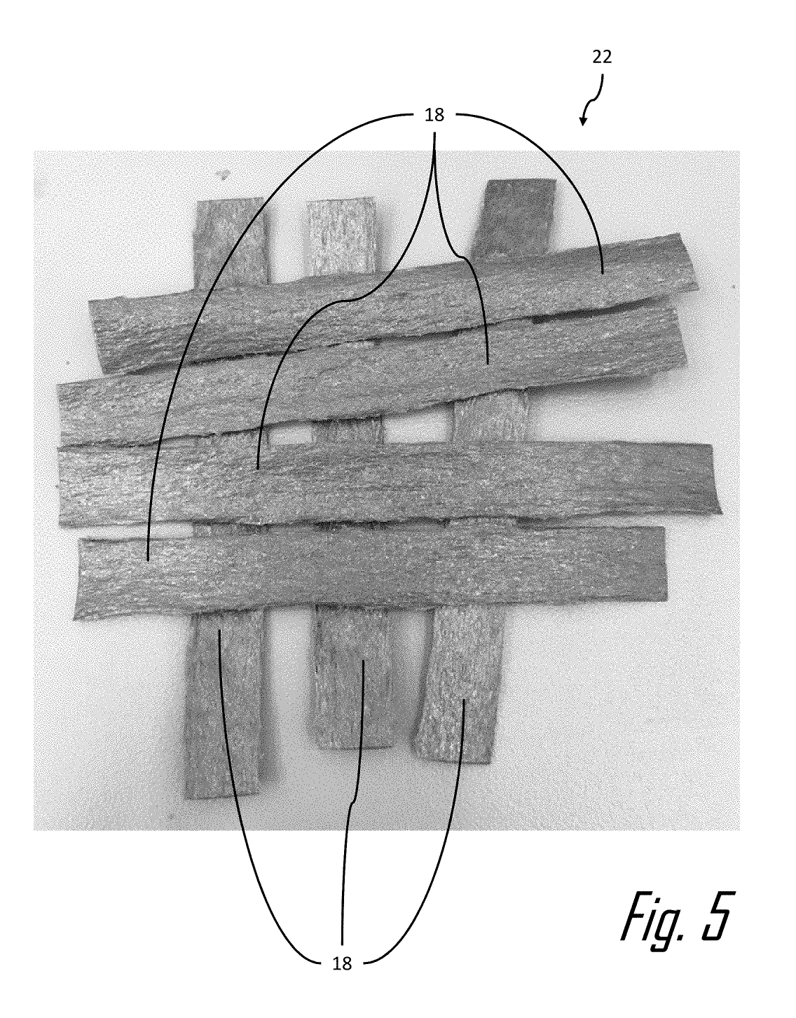

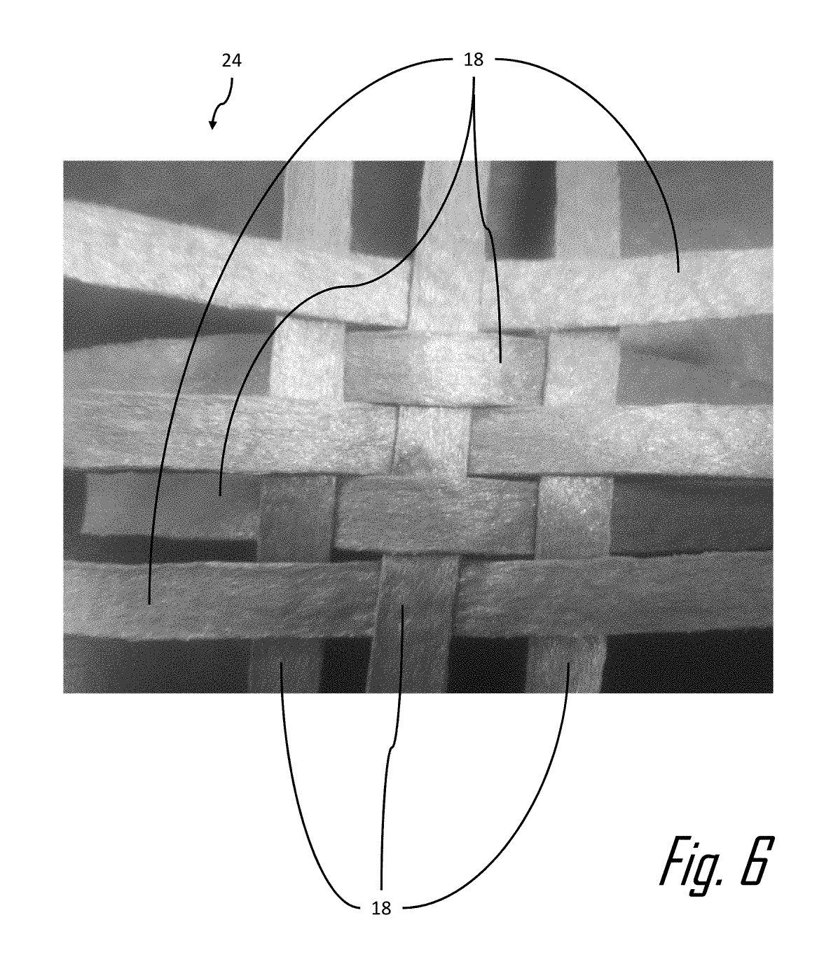

STEP 114, ARRANGE THE PLURALITY OF CONDUCTIVE POLYMER TAPES IN A DESIRED ORIENTATION, is an optional step that includes arranging the plurality of conductive polymer tapes 18 in a desired orientation, such as in adjacent parallel fashion 20 as shown in FIG. 4, an overlapping perpendicular fashion 22 as shown in FIG. 5, or an interwoven fashion 24 as shown in FIG. 6.

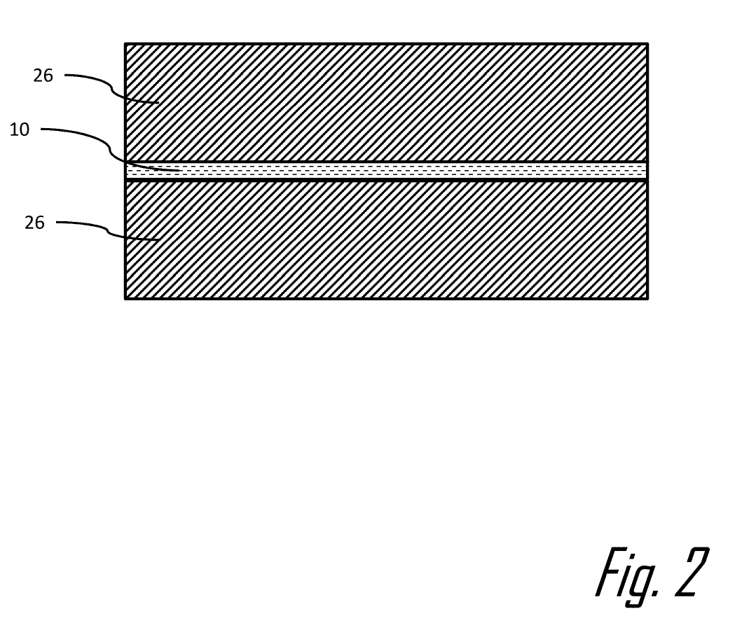

STEP 116, APPLY A DESIRED PRESSURE TO AT LEAST A PORTION OF THE ARTICLE WHILE SIMULTANEOUSLY HEATING AT LEAST A PORTION OF THE ARTICLE TO A DESIRED TEMPERATURE, includes applying a desired pressure to at least a portion of the article 10 while simultaneously heating at least a portion of the article 10 to a desired temperature. In a non-limiting example the article 10 is disposed between the platens 26 of a heated press (see FIG. 2), such a Model 12-12H produced by Carver, Inc. of Wabash, Ind. and the pressure and heat required to obtain the desired pressure and temperature are provided by the heated press. The desired pressure is about 27,580 kilopascals (2 tons per inch²) and the desired temperature is in a range from about 163° C. to about 190° C. (about 325° F. to about 375° F.). As used herein, the term “about” means that the value of the modified unit may vary ±5% from the stated value.

STEP 118, MAINTAIN THE DESIRED PRESSURE AND THE DESIRED TEMPERATURE ON THE AT LEAST A PORTION OF THE ARTICLE FOR A DESIRED TIME PERIOD, includes maintaining the desired pressure and the desired temperature on the at least a portion of the article 10 for a desired time period. In this non-limiting example the desired time period is about ten minutes.

According to one embodiment of the invention, a conductive polymer tape 18 having enhanced surface electrical conductivity was formed by performing STEPS 110, 116, and 118 of the method 100. According to this embodiment, the conductive polymer article 10 is provided in the form of a conductive polymer tape 18 having a thickness of about 0.25 millimeters.

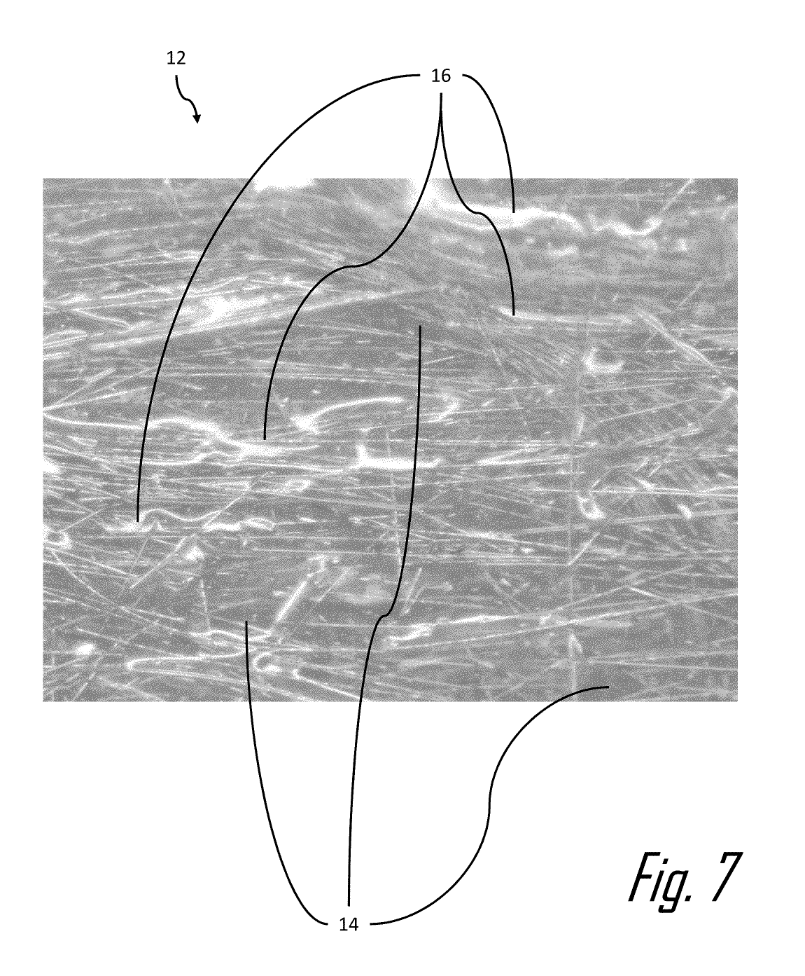

FIG. 7 shows a photomicrograph of the polymer-rich skin layer on the surface of the conductive polymer tape 18 processing according to method 100. The conductive polymer tape 18 in this non-limiting example is made of a polyamide (NYLON) material filled with 10% to 14% nickel plated carbon fibers 16 by volume. The nickel plated carbon fibers 16 have diameter of about 5 to 10 microns and a length of 3 to 6 millimeters. As can be seen in this photomicrograph, there are regions of the surface that are composed primarily of the polymer material 14 (dark regions). In addition, the conductive fibers 16 (light regions) are generally oriented along the direction of extrusion, reducing the number of interconnections between the conductive fibers 16. Both of these conditions contribute to a reduced surface electrical conductivity (i.e., increased surface electrical resistance) of skin layer. The surface resistance of the conductive polymer tape 18 as measured by a standard millimeter was 38Ω to 170Ω.

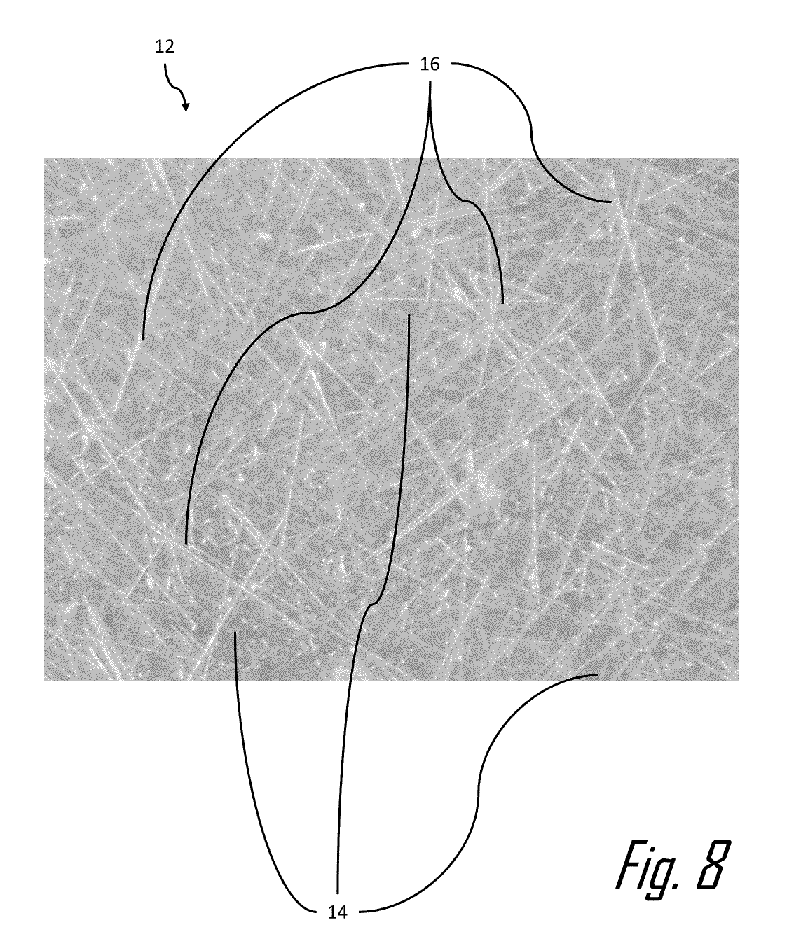

This conductive polymer tape 18 was then subjected to a pressure of about 27,580 kilopascals (2 tons per inch²) at a temperature of about 177° C. (350° F.) for about ten minutes in a heated press according to method 100. The photomicrograph of FIG. 8, taken after processing the plurality of tapes into a film according to method 100, shows the surface of the conductive polymer tape 18. As can be seen by comparing FIG. 7 with FIG. 8, the size of the regions on the surface that are composed primarily of the polymer material 14 (dark regions) are greatly diminished, reducing the electrically insulative polymer material 14 on the surface. In addition, the orientation of the conductive fibers 16 is more randomized, thus improving the electrical connections between the conductive fibers 16. Following this processing, the surface resistance of the conductive polymer tape 18 was measured again and the resistance measurements were found to be in the range of 2Ω to 105Ω, confirming an improvement in surface conductivity.

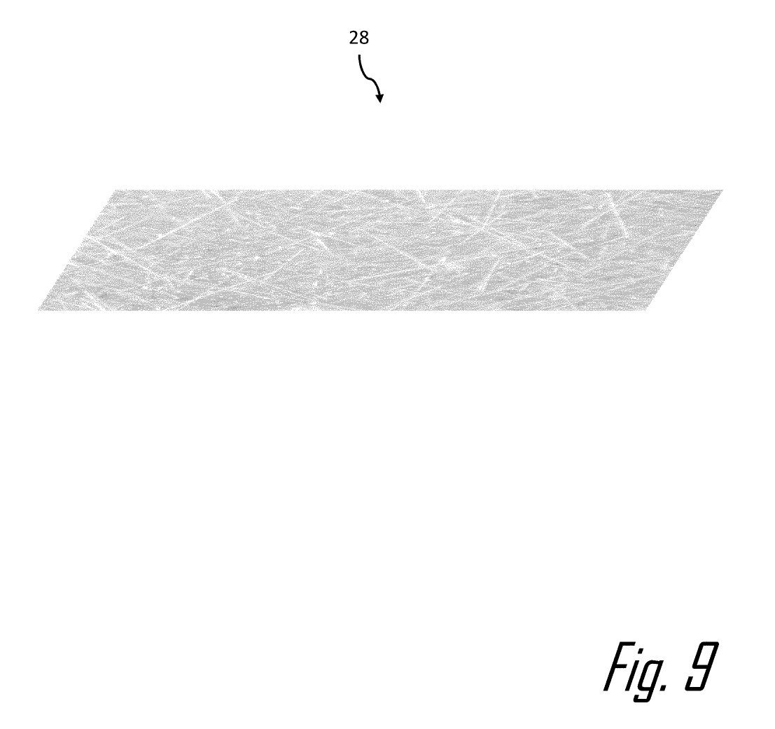

According to another embodiment of the invention, a conductive polymer film sheet 28 having enhanced surface electrical conductivity was formed by performing STEPS 110 , 112, optional STEPS 114, 116, and STEP 118 of the method 100. According to this embodiment, the conductive polymer article 10 is provided in the form of a plurality of extruded conductive polymer tapes 18 having a thickness of about 0.1 millimeters to about 4 millimeters. The plurality of conductive polymer tapes 18 were arranged according to one of the various arrangements shown in FIGS. 4-6. The arrangement of conductive polymer tapes 18 was then subjected to a pressure of about 27,580 kilopascals (2 tons per inch²) at about 177° C. (350° F.) for about ten minutes in a heated press according to method 100. The resulting conductive polymer film sheet 28 is shown in FIG. 9. Such a conductive polymer film sheet 28 could be used to provide EMC and/or EMI shielding by vacuum forming the conductive polymer film sheet 28 to the exterior of an electrical assembly, such as a connector body (not shown). This would provide an advantage of using much less conductive polymer material that a connector body molded entirely of a conductive polymer material.

The desired combinations of pressure, temperature and time presented for the method 100 herein have been found to produce satisfactory improvements in surface conductivity. However, these combinations of pressure, temperature and time conditions have not yet been optimized, so other combinations of pressure, temperature, and time may be found to produce satisfactory or even superior results.

While the examples of conductive polymer materials presented herein are nickel plated carbon fiber filled polyamide materials, alternative embodiments with the conductive polymer material containing other polymeric materials, such as polybutylene terephthalate (PBT), polypropylene (PP), or polyethylene (PE), and/or other conductive fibers, such as copper plated carbon fibers, may be envisioned.

While the embodiments of the method 100 presented herein show a heated press used to provide pressure and heat, alternative embodiments, such as using a heated roller for processing conductive polymer films, may also be envisioned. In other embodiments, heat and pressure may alternatively be applied by the horn of an ultrasonic welding machine.

While the embodiments presented herein are directed to extruded conductive polymer tapes, alterative embodiments directed to methods of enhancing surface electrical conductivity of molded article formed of a conductive polymer material and the articles produced by such a method may also be envisioned. The heat and pressure applied during the method 100 could cause deformation in the molded article, so care should be taken to provide countermeasures for the distortion in the design of the molded article, such as dimensioning the molded article to account for the deformation or selecting a portion of the molded article to apply the heat and pressure where deformation would not impact the performance of the article.

Accordingly, a method of enhancing surface electrical conductivity of an article formed of a conductive polymer material and a conductive polymer material produced by such a method is provided. The method improves the surface conductivity (i.e. lowers surface resistivity) by diminishing the polymer-rich surface layer and reorienting the conductive fibers in a more random fashion. The method provides the enhanced surface conductivity without the use of mechanical surface treatments, chemical surface treatments, water soluble resins, metal films, or conductive paints.

While this invention has been described in terms of the preferred embodiments thereof, it is not intended to be so limited, but rather only to the extent set forth in the claims that follow. Moreover, the use of the terms first, second, etc. does not denote any order of importance, but rather the terms first, second, etc. are used to distinguish one element from another. Furthermore, the use of the terms a, an, etc. do not denote a limitation of quantity, but rather denote the presence of at least one of the referenced items.

We claim:

1. A method of enhancing surface electrical conductivity of an article formed of a conductive polymer material, comprising the steps of:
providing an article formed of a conductive polymer comprising a dielectric polymeric material and conductive fibers;
applying a desired pressure to at least a portion of the article while simultaneously heating the at least a portion of the article to a desired temperature; and
maintaining the desired pressure and the desired temperature on the at least a portion of the article for a desired time period.

2. The method according to claim 1, wherein the desired pressure is about 27,580 kilopascals.

3. The method according to claim 1, wherein the desired temperature is in a range from about 163° C. to about 190° C.

4. The method according to claim 1, wherein the desired time period is about 10 minutes.

5. The method according to claim 1, wherein the dielectric polymeric material is polyamide and the conductive fibers are nickel plated carbon fiber.

6. A method forming a conductive polymer film having enhanced surface electrical conductivity, comprising the steps of:
providing an extruded conductive polymer tape comprising a dielectric polymeric material and conductive fibers;
applying a desired pressure to the conductive polymer tape while simultaneously heating the conductive polymer tape to a desired temperature; and
maintaining the desired pressure and the desired temperature for a desired time period.

7. The method according to claim 6, wherein the desired pressure is about 27,580 kilopascals.

8. The method according to claim 6, wherein the desired temperature is in a range from about 163° C. to about 190° C.

9. The method according to claim 6, wherein the desired time period is about 10 minutes.

10. The method according to claim 6, further comprising the steps of:
providing the conductive polymer tape in the form of a plurality of conductive polymer tapes comprising a dielectric polymeric material and conductive fibers; and
arranging the plurality of conductive polymer tapes in a desired orientation.

11. The method according to claim 10, wherein the plurality of conductive polymer tapes are arranged in an adjacent parallel fashion.

12. The method according to claim 10, wherein the plurality of conductive polymer tapes are arranged in an overlapping perpendicular fashion.

13. The method according to claim 10, wherein the plurality of conductive polymer tapes are interwoven.

14. A conductive polymer tape having enhanced surface electrical conductivity, formed by a method comprising the steps of:
providing of a conductive polymer tape comprising a dielectric polymeric material and conductive fibers;
applying a desired pressure to the conductive polymer tape while simultaneously heating the conductive polymer tape to a desired temperature; and
maintaining the desired pressure and the desired temperature for a desired time period.

15. The conductive polymer tape according to claim 14, wherein the desired pressure is about 27,580 kilopascals.

16. The conductive polymer tape according to claim 14, wherein the desired temperature is in a range from about 163° C. to about 190° C.

17. The conductive polymer tape according to claim 14, wherein the desired time period is about 10 minutes.

18. The conductive polymer tape according to claim 14, wherein the dielectric polymeric material is polyamide and the conductive fibers are nickel plated carbon fiber.

19. The conductive polymer tape according to claim 14, wherein the method further comprises the steps of:
providing the conductive polymer tape in the form of a plurality of conductive polymer tapes comprising a dielectric polymeric material and conductive fibers; and
arranging the plurality of conductive polymer tapes in a desired orientation.

20. The conductive polymer tape according to claim 14, wherein desired orientation is selected from the group consisting of arranging the plurality of conductive polymer tapes in an adjacent parallel fashion, arranging the plurality of conductive polymer tapes in an overlapping perpendicular fashion, and arranging the plurality of conductive polymer tapes in an interwoven fashion.
